(19) United States
(12) Patent Application Publication
(10) Pub. No.: US 2003/0037244 A1
(43) Pub. Date: Feb. 20, 2003

(54) System management interrupt generation upon completion of cryptographic operation

(75) Inventors: Steven Dale Goodman, Raleigh, NC (US); James Patrick Hoff, Raleigh, NC (US); Randall Scott Springfield, Chapel Hill, NC (US); James Peter Ward, Raleigh, NC (US)

Correspondence Address: International Business Machines Corporation, Intellectual Property Law, Dept. 9CCA/Bldg. 002-2, Personal and Printing Systems Group, P.O. Box 12195, Research Triangle Park, NC, 27709, US

(73) Assignee: International Business Machines Corporation, Armonk, NY

(21) Appl. No.: 09/931,550

(22) Filed: Aug. 16, 2001

(51) Int. Cl. H04L 9/00

(52) U.S. Cl. 713/189

(57) ABSTRACT

An SMI (System Management Interrupt) generation capability is added to the cryptographic verification operation utilized to verify an update of a system management utility, such as the BIOS update utility. With the addition of an SMI upon completion of a signature verification command, the SMI handler issues a signature verification request to a trusted platform module (TPM) and returns control to the controlling application with a status code indicating it should begin polling the SMI handler for status. Upon completion of the verification operation, the TPM issues the SMI. The SMI handler then queries the TPM for status. The SMI handler then updates its internal status and permits access to the requested resource assuming the verification is successful. Upon the next poll from the application, the SMI handler returns the status to the calling application, which would either continue or abort with the update operation.

### CROSS-REFERENCE TO RELATED APPLICATIONS

The present application relates to

U.S. patent application Ser. No. ______ [Attorney Docket No. RPS9-2001-0043], entitled “Proving BIOS Trust in a TCPA Compliant System”; and

U.S. patent application Ser. No. ______ [Attorney Docket No. RPS9-2001-0046], entitled “Flash Update Using a Trusted Platform Module,” which are hereby incorporated by reference herein.

### TECHNICAL FIELD

The present invention relates in general to information handling systems, and in particular, to the update of information in an information handling system.

### BACKGROUND INFORMATION

The Basic Input/Output System (BIOS) of a computer is the backbone of the operation of that computer. The BIOS is programming that controls the basic hardware operations of the computer, including interaction with floppy disk drives, hard disk drives and the keyboard. Because of ever changing computer technologies, even though a computer may still be acceptable to a user, often the BIOS of that computer will not support all of the new technologies.

A conventional method for upgrading the BIOS code or image of a computer is to physically replace the Read-Only-Memory (ROM) based BIOS, which in networks systems, would entail replacing the ROM-BIOS in each processor node, which is very time consuming and adds to the overall system down-time of the network.

There have been solutions for updating a BIOS image associated with a processor without having to physically replace the ROM-BIOS at each computer in the network. For example, one solution is to provide the computer with a Flash EPROM for the BIOS, also known as a Flash BIOS. With a Flash BIOS, the BIOS image or a portion of the BIOS image can be updated by a software update. This is often performed by downloading or storing the Flash information onto a media storage device, such as a floppy disk, and using the disk at each computer to flash the BIOS. However, this is very time consuming, especially with large network systems. Further, some of the computers on the network may not have floppy drives or the proper medium transfer device.

A second method is to send the flash over the network to each computer in the network. The problem with this method is that the flash is subject to someone introducing malicious code, such as a virus, to the flash, thereby causing the BIOS to be flashed with a corrupt image.

Yet another method includes transferring the flash information from the source computer to the receiving computer, with the flash information including the flash code, the flash code instructions and an encrypted digital signature corresponding to the identification of the flash code. The sender is authenticated and then the receiving computer is operably placed in a secure mode. A hash value corresponding to the flash information is calculated, and the digital signature from the flash information is decrypted. The flash code is validated by comparing the digital signature of the flash information to the calculated hash, and if validated, the BIOS is flashed with the new flash code, the new flash code is verified, and the computer re-booted power cycled. However, cryptographic verification of system management utilities (e.g., BIOS update utilities) must be done in a secure manner. In most PC systems, the most secure way to do this is to have a system management interrupt (SMI) handler perform a cryptographic verification of the flash utility and update image. The time required to perform this verification may force the SMI handler to relinquish control while the computation is performed. Therefore, there is a need in the art for a way for the SMI handler to regain control after the cryptographic verification operation is complete.

### SUMMARY OF THE INVENTION

The present invention addresses the foregoing need by adding an SMI generation capability to the cryptographic verification operation utilized to verify an update of a system management utility, such as the BIOS update utility. With the addition of an SMI upon completion of a signature verification command, the SMI handler issues a signature verification request to a Trusted Platform Module (TPM) and returns control to the controlling application with a status code indicating it should begin polling the SMI handler for status. Upon completion of the verification operation, the TPM issues the SMI. The SMI handler then queries the TPM for status. The SMI handler then updates its internal status and permits access to the requested resource assuming the verification is successful. Upon the next poll from the application, the SMI handler returns the status to the calling application, which would either continue or abort with the update operation.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIGS. 1-3 illustrate flow diagrams configured in accordance with the present invention; and

FIG. 4 illustrates an information handling system configured in accordance with the present invention.

### DETAILED DESCRIPTION

In the following description, numerous specific details are set forth such as specific update utilities, etc. to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted in as much as such details are not necessary to obtain a complete understanding of the present invention and are within the skills of persons of ordinary skill in the relevant art.

The present invention makes use of common cryptographic algorithms. Such cryptographic algorithms may be key-based, where special knowledge of variable information called a “key” is required to decrypt ciphertext. There are two prevalent types of key-based algorithms: “symmetric” (also called secret key or single key algorithms) and “public key” (also called asymmetric algorithms). The security in these algorithms is centered around the keys—not the details of the algorithm itself. With asymmetric public key algorithms, the key used for encryption is different from the key used for decryption. It is generally very difficult to calculate the decryption key from an encryption key. In a typical operation, the “public key” used for encryption is made public via a readily accessible directory, while the corresponding “private key” used for decryption is known only to the receipt of the ciphertext. In an exemplary public key transaction, a sender retrieves the recipient's public key and uses it to encrypt the message prior to sending it. The recipient then decrypts the message with the corresponding private key.

It is also possible to encrypt a message using a private key and decrypt it using a public key. This is sometimes used in digital signatures to authenticate the source of a message, and is a process utilized within the present invention.

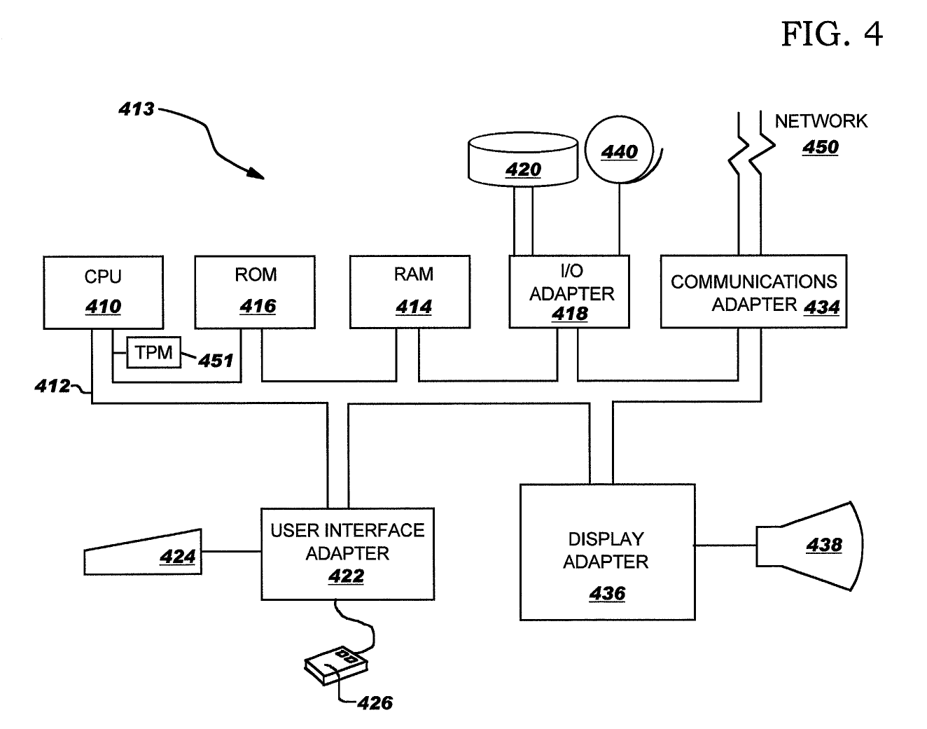

Referring to FIG. 4, an example is shown of a data processing system 413 which may be used for the invention. The system has a central processing unit (CPU) 410, which is coupled to various other components by system bus 412. Read only memory (“ROM”) 416 is coupled to the system bus 412 and includes a basic input/output system (“BIOS ”) that controls certain basic functions of the data processing system 413. Random access memory (“RAM”) 414, I/O adapter 418, and communications adapter 434 are also coupled to the system bus 412. I/O adapter 418 may be a small computer system interface (“SCSI”) adapter that communicates with a disk storage device 420. Communications adapter 434 interconnects bus 412 with an outside network 450 enabling the data processing system to communicate with other such systems. Input/Output devices are also connected to system bus 412 via user interface adapter 422 and display adapter 436. Keyboard 424 and mouse 426 are interconnected to bus 412 via user interface adapter 422. Display monitor 438 is connected to system bus 412 by display adapter 436. In this manner, a user is capable of inputting to the system throughout the keyboard 424 or mouse 426 and receiving output from the system via display 438.

Implementations of the invention include implementations as a computer system programmed to execute the method or methods described herein, and as a computer program product. According to the computer system implementation, sets of instructions for executing the method or methods may be resident in the random access memory 414 of one or more computer systems configured generally as described above. Until required by the computer system, the set of instructions may be stored as a computer program product in another computer memory, for example, in disk drive 420 (which may include a removable memory such as an optical disk or floppy disk for eventual use in the disk drive 420). Further, the computer program product can also be stored at another computer and transmitted when desired to the user's workstation 413 by a network or by external network 450 such as the Internet. One skilled in the art would appreciate that the physical storage of the sets of instructions physically changes the medium upon which it is stored so that the medium carries computer readable information. The change may be electrical, magnetic, chemical, biological, or some other physical change. While it is convenient to describe the invention in terms of instructions, symbols, characters, or the like, the reader should remember that all of these and similar terms should be associated with the appropriate physical elements.

Note that the invention may describe terms such as comparing, validating, selecting, identifying, or other terms that could be associated with a human operator. However, for at least a number of the operations described herein which form part of at least one of the embodiments, no action by a human operator is desirable. The operations described are, in large part, machine operations processing electrical signals to generate other electrical signals.

The present invention is described with respect to the update of a BIOS image within a data processing system, such as system 413. However, the present invention is applicable to the update of any data and/or image within an information handling system.

The present invention makes use of the TCPA (Trusted Computing Platform Alliance) Specification where a trusted platform module (TPM) 451 has been installed within system 413. The TCPA Specification is published at www.trustedpc.org/home/home.htm, which is hereby incorporated by reference herein. However, it should be noted that the present invention may also be implemented using other cryptographic verification methods and processes.

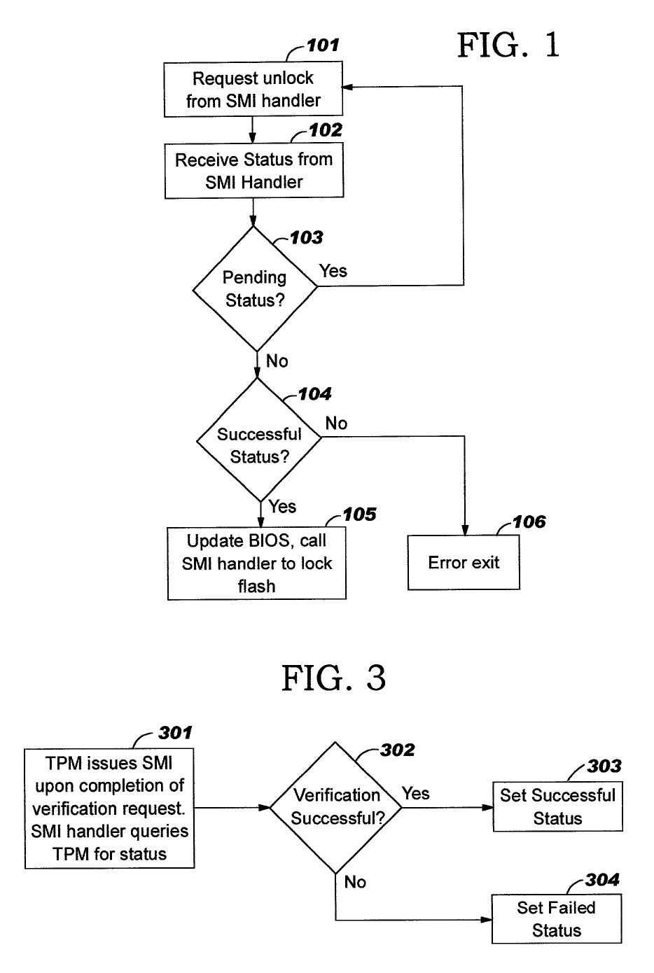

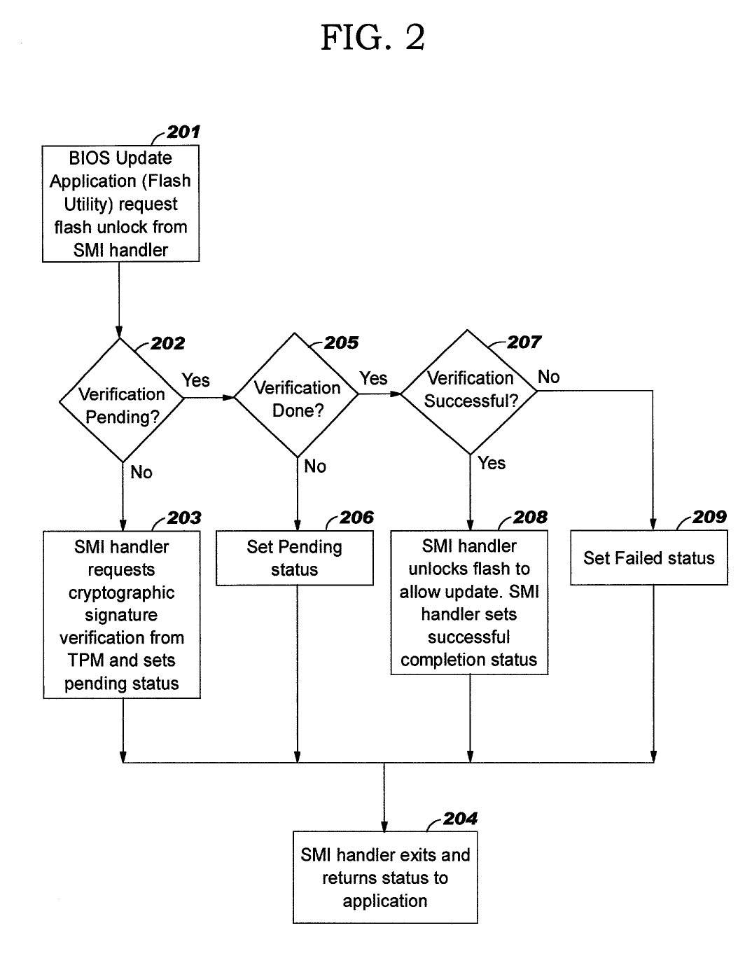

Referring to FIG. 1, system 413, either automatically, or as a result of input from a user, will begin a process where the BIOS image is to be updated. Such a BIOS image may reside within ROM 416 or some other memory module within system 413. The update of the BIOS image may be received over a network 450 or on a diskette. In step 101, the flash application will initially request an unlock of the BIOS image from an SMI handler. FIG. 2 illustrates a process for implementing such an SMI handler in accordance with the present invention, wherein step 201, the BIOS update application (flash utility) requests a flash unlock from the SMI handler.

A receipt of an SMI causes the system to enter into a mode referred to as system management mode (SMM). SMIs can be asserted by an SMI timer, by a system request, or by other means, such as an application. An SMI is a non-maskable interrupt having almost the highest priority in the system 413. When an SMI is asserted, CPU 410 maps a portion of memory referred to as the system management mode memory (SMM memory) into the main memory space (e.g., RAM 414). The entire CPU 410 state is then saved in the SMM memory in stack-like, last in/first out fashion. After the initial processor state is saved, CPU 410 begins executing an SMI handler routine, which is an interrupt service routine typically performing system management tasks such as reducing power to specific devices or, as in the case of the present invention, providing a secure means for updating a flash utility. While the routine is executing, other interrupt requests are not serviced, and are ignored until the interrupt routine is completed or the CPU 410 is reset. When the SMI handler completes its task, the processor state is retrieved from the SMM memory, and the main program continues.

In step 202, a determination is made whether a verification of the BIOS update image is still pending. Since at this point, verification is not pending, the process will continue to step 203, where an SMI handler requests cryptographic signature verification from the TPM 451 and sets a status code as Pending. The process in FIG. 2 will then proceed to step 204, where the SMI handler exits and returns the Pending status to the BIOS update application of FIG. 1. In FIG. 1, it is at this point that the process will proceed to step 102, where the Pending status set in step 203 is received from the SMI handler, and since the status code is set as Pending, in step 103, the process of FIG. 1 will loop back to step 101.

While this is occurring, step 203 has caused the initiation of the process in FIG. 3. In step 301, the TPM 451 issues an SMI upon completion of a verification request (step 203) and an SMI handler queries the TPM 451 for the status of such cryptographic verification process. The TPM 451 may utilize a signature verification process that is a standard method that is used in many cryptographic systems. The sender of the BIOS image computes a “hash” of the original work (a hash is a mathematical computation that is performed on the input; the computation is designed such that the probability of being able to recreate the output without the identical input is low). Then the hash is encrypted using the sender's private key. This encrypted result is called the signature. When the receiver, the TPM 451, wishes to verify that the image is authentic, the TPM 451 computes the hash of what was received. The TPM 451 then decrypts the sender's signature by using the sender's public key and compares it to the newly computed hash. If they are identical, the TPM 451 then determines that the update image is authentic and has not been modified in transit.

Assume, for example, that the process in FIG. 3 is still pending. The process in FIG. 1 will continue, whereas in step 101, another request to unlock is sent to the SMI handler. This initiates the process in FIG. 2, where from step 201, the process goes to step 202. Since the verification process of FIG. 3 is still pending, i.e., the status is still Pending, the process proceeds to step 205 to determine whether the verification process in FIG. 3 has been completed. Since in this example it has not, the process proceeds to step 206 to confirm that the status of the operation of the present invention is still in a Pending state, and the SMI handler exits in step 204 returning to step 102 in FIG. 1. Since in step 103, the status is still Pending, the process again loops back to step 101.

Next, assume that the verification process in step 301 has completed, and the TPM has determined that the BIOS update image received by system 413, such as through network 450, or on a diskette, has resulted in a verification that the image is authentic. As a result, the process in FIG. 3 will proceed from step 302 to step 303 to set the status as Successful.

Again, the process illustrated in FIG. 1 will operate with step 101 reoccurring, where a request to unlock is sent to the SMI handler (step 201). Since in step 202, verification is still Pending, the process will proceed to step 205. Since verification has been completed, the process will proceed to step 207, where since verification has been Successful, the process proceeds to step 208. The SMI handler will now unlock the flash memory to allow the update of the BIOS image and the SMI handler sets the status as a successful completion. In step 204, the SMI handler exits and returns the process to step 102 in FIG. 1. Since the status is no longer Pending, the process proceeds from step 103 to step 104. The status being Successful, the process proceeds to step 105, where the BIOS has been updated, and the SMI handler is now called to lock the flash memory.

If in the process of FIG. 3, the verification has not been successful in step 302, the process would have proceeded to step 304 to set the status as Failed. Then, in step 102, in FIG. 1, when the Failed status was received from the SMI handler, the process would have proceeded to step 103 where the status is no longer pending, causing the process to proceed to step 104. Since the Successful status has not been set, but instead it has been set as Failed, the process proceeds to step 106 to exit an Error. If the process in FIG. 1 had been at step 101, this would have caused the process in FIG. 2 to begin again. Since the status was set as Failed in step 304, the process in FIG. 2 would have proceeded to steps 201, 202, 205, 207 on toward step 209 to set the status as failed again. This Failed status would have then been returned to step 102 by step 204, again causing the process in FIG. 1 to proceed through steps 103, 104, toward step 106.

Although the present invention and its advantages have been described in detail, it should be understood that various changes, substitutions and alterations can be made herein without departing from the spirit and scope of the invention as defined by the appended claims.

What is claimed is:

1. In a data processing system, a method for updating a utility, comprising the steps of:
receiving a request to unlock the utility;
verifying an update to the utility; and
using a system management interrupt (SMI) handler to query a status of the verifying step.

2. The method as recited in claim 1, further comprising the step of:
if the verifying step successfully verifies the update of the utility, unlocking the utility and updating the utility.

3. The method as recited in claim 1, further comprising the step of:
not unlocking the utility if the verifying step fails to verify the update to the utility.

4. The method as recited in claim 2, wherein the verifying step is performed by a trusted platform module (TPM) in accordance with Trusted Computing Platform Alliance Specifications.

5. The method as recited in claim 4, wherein the SMI handler used to query the status of the verifying step queries the TPM for the status.

6. The method as recited in claim 5, wherein the SMI handler is issued by the TPM.

7. The method as recited in claim 2, further comprising the step of:
after the utility has been updated, locking the utility with the SMI handler.

8. The method as recited in claim 1, wherein the utility is a flash utility.

9. The method as recited in claim 2, wherein the requesting step is performed by an SMI handler.

10. A computer program product adaptable for storage on a computer readable medium and operable for updating a utility, comprising:
programming for receiving a request to unlock the utility;
programming for verifying an update to the utility; and
programming for using a system management interrupt (SMI) handler to query a status of the verifying programming.

11. The computer program product as recited in claim 10, further comprising:
if the verifying programming successfully verifies the update of the utility, programming for unlocking the utility and updating the utility.

12. The computer program product as recited in claim 10, further comprising:
programming for not unlocking the utility if the verifying programming fails to verify the update to the utility.

13. The computer program product as recited in claim 11, wherein the verifying programming is performed by a trusted platform module (TPM) in accordance with Trusted Computing Platform Alliance Specifications.

14. The computer program product as recited in claim 13, wherein the SMI handler used to query the status of the verifying programming queries the TPM for the status.

15. The computer program product as recited in claim 14, wherein the SMI handler is issued by the TPM.

16. The computer program product as recited in claim 11, further comprising:
after the utility has been updated, programming for locking the utility with the SMI handler.

17. The computer program product as recited in claim 11, wherein the requesting programming is performed by an SMI handler.

18.A data processing system comprising:
a processor;
a trusted platform module (TPM) coupled to the processor and operating under Trusted Computing Platform Alliance Specifications;
a BIOS utility stored in flash memory coupled to the processor;
an input circuit for receiving an update to the BIOS utility; and
a bus system for coupling the input circuit to the processor;
a BIOS update application requesting an unlock of the flash memory from a system management interrupt (SMI) handler;
the SMI handler including programming for requesting cryptographic verification of the BIOS utility update from the TPM;
the TPM including programming for verifying an authenticity of the BIOS utility update;
the TPM including programming for issuing an SMI to query the TPM for a status on the verifying of the authenticity of the BIOS utility update;
the SMI handler unlocking the flash memory if the SMI handler sets the status as successful;
the BIOS update application updating the BIOS utility with the update; and
the SMI handler locking the flash memory after the update of the BIOS utility has completed.

19.A method comprising the steps of:
(a) a BIOS update application requesting an unlock of a flash utility from a system management interrupt (SMI) handler;
(b) determining if a verification of an update to the flash utility is pending;
(c) if verification of the update to the flash utility is not pending, the SMI handler requesting verification of the update to the flash utility from a trusted platform module (TPM) and setting a status flag as pending;
(d) exiting the SMI handler and returning status flag to the BIOS update application;
(e) receiving by the BIOS update application the status flag from the SMI handler;
(f) returning to step (a) if the status flag is set as pending after step (e);
(g) in response to step (c), the TPM verifies the update to the flash utility;
(h) when step (g) is completed, issuing an SMI by the TPM to query if the verification of the update to the flash utility was successful or failed;
(i) setting the status flag as successful if the verification of the update to the flash utility was successful;
(j) setting the status flag as failed if the verification of the update to the flash utility was not successful;
(k) if step (b) determines that verification of the update to the flash utility is still pending, determining if the verification of the update to the flash utility has completed;
(l) if step (k) determines that verification of the update to the flash utility has not completed, setting the status flag as pending;
(m) if step (k) determines that verification of the update to the flash utility has completed, determining if the verification of the update to the flash utility was successful;
(n) if step (m) determines that the verification of the update to the flash utility was not successful, setting the status flag as failed;
(o) if step (m) determines that the verification of the update to the flash utility was successful, the SMI handler unlocking the flash utility and setting the status flag as successful;
(p) performing steps (d) and (e) in response to any of steps (l), (n), or (o);
(q) determining if the status flag is set as successful if after step (e) it is determined that the status flag is not set to pending; and
(r) updating the BIOS with the update to the flash utility and locking the flash utility with the SMI handler if the status flag is determined to be set to successful in step (q).
